(19) United States
(12) Patent Application Publication
(10) Pub. No.: US 2011/0058893 A1
(43) Pub. Date: Mar. 10, 2011

(54) CONTINUOUSLY VARIABLE POSITIONING DEVICE

(76) Inventor: Werner O. Merlo, Spruce Grove (CA)

(21) Appl. No.: 12/673,612

(22) PCT Filed: Aug. 15, 2008
(86) PCT No.: PCT/CA08/01458

§ 371 Date: Feb. 16, 2010

Related U.S. Application Data
(60) Provisional application No. 60/956,564, filed on Aug. 17, 2007.

(51) Int. Cl. F16B 7/00

(52) U.S. Cl. 403/104

(57) ABSTRACT

A continuously variable positioning device includes a first body having a first engagement surface. At least part of the first engagement surface is covered with a pattern of movable actuators. A second body has a second engagement surface in contact with the first engagement surface. At least a part of the second engagement surface having an actuator engaging profile, at least some of the movable actuators being depressed and others of the movable actuators being extended to conform to the actuator engaging profile. A drive assembly is provided for creating relative movement of the first body and the second body while maintaining the first engagement surface continuously engaged with the second engagement surface, the movable actuators moving axially during relative movement of the first body and the second body.

### FIELD

Positioning device for continuously varying the relative position of two bodies, such as a joint.

### BACKGROUND

Most mechanical positioning devices use a friction-based or pin-in-hole type locking system. These systems suffer from the difficulty in maintaining positions against multilateral forces, their inability of adapting to multidimensional joint applications, the need for a strong locking force, a limited number of locking positions, questionable weight bearing strength, and difficulty in obtaining 3D locking capability.

U.S. Pat. No. 6,238,124 (Merlo) describes a repositionable joint that is suitable for use in a prosthetic arm. The joint has two parts with engaging surfaces that can be pulled apart to adjust the relative orientation of each, and lock together to maintain the desired position.

### SUMMARY

According to one aspect, there is provided a continuously variable positioning device. The continuously variable positioning device has a first body having a first engagement surface. At least part of the first engagement surface is covered with a pattern of movable actuators. There is also a second body having a second engagement surface in contact with the first engagement surface. At least a part of the second engagement surface has an actuator engaging profile. At least some of the movable actuators are depressed and others of the movable actuators are extended to conform to the actuator engaging profile. Means are provided for creating relative movement of the first body and the second body while maintaining the first engagement surface continuously engaged with the second engagement surface. The movable actuators move axially during relative movement of the first body and the second body.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a prior art joint locking mechanism.

FIG. 2 is a perspective view of a continuously variable positioning device.

FIG. 3 is a side elevation view in section of the continuously variable positioning device in a first position.

FIG. 4 is a side elevation view in section of the continuously variable positioning device in a second position.

FIG. 5 is a side elevation view in section of the continuously variable positioning device in a third position.

FIG. 6 is a perspective view of the continuously variable positioning device with an actuator.

FIG. 7 is a top plan view of an alternative actuator.

FIG. 8 is a side elevation view in section of the continuously variable positioning device with an outer enclosure.

FIG. 9 is a side elevation view in section of the continuously variable positioning device with an outer enclosure in a disengaged position.

FIG. 10 is a side elevation view in section of the continuously variable positioning device with an outer enclosure in a locked position.

FIG. 11 is a side elevation view of a planar second body, and position-controllable movable actuators.

### DETAILED DESCRIPTION

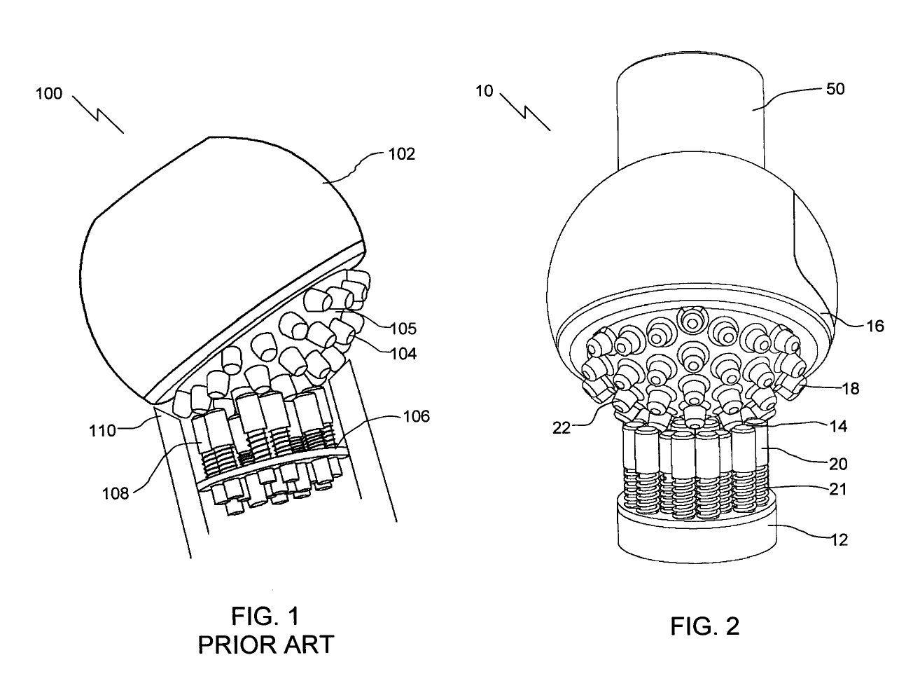

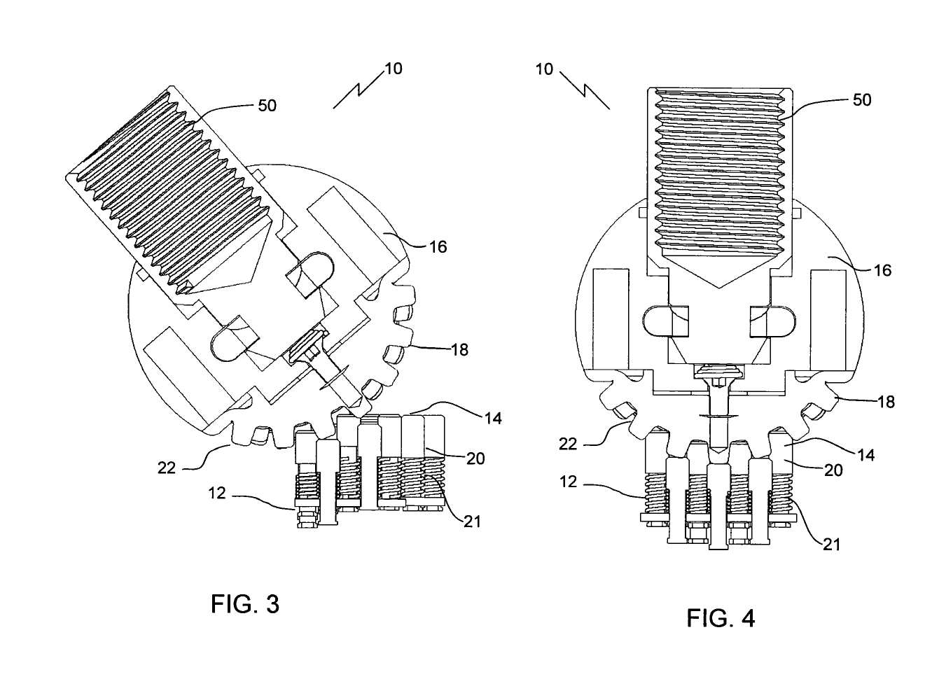

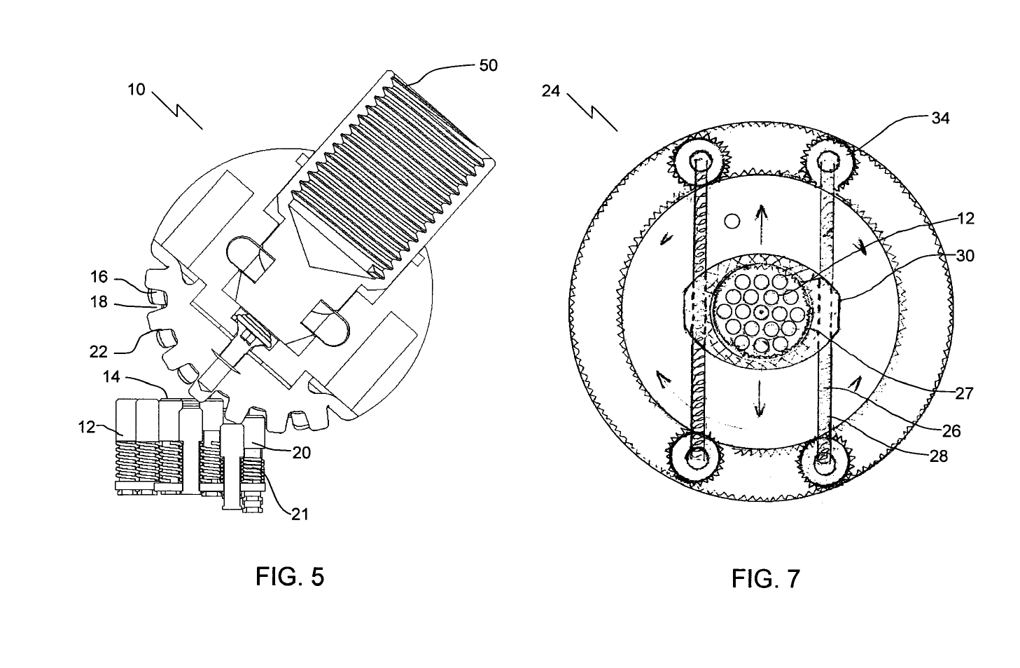

A prior art device will be described with reference to FIG. 1. The preferred embodiment, a continuously variable positioning device generally identified by reference numeral 10, will then be described with reference to FIG. 2 through 11.

### Structure and Relationship of Parts:

Referring to FIG. 1, a prior art “passive-locking” joint is shown. In this joint, a rounded object 102 such as a ball or part thereof has a surface covered with polygonal patterns of spaced apart protuberances 104. The spaces between protuberances 104 are cavities 105. When an assembly 106 of closely spaced, pressure sensitive actuators 108 are imprinted against the protuberances 104, the actuators 108 emulate a mirror image of the opposing surface. Actuators 108 contacting protuberances 104 are pushed back, while unobstructed actuators 108 penetrate into the cavities 105 between protuberances 104. Once trapped in a cavity 105, the actuators 108 are unable to move in any direction, thereby freezing the spatial orientation between actuators 108 and ball surface 102 against forces of pitch, yaw and roll (the three degrees of freedom). As soon as the actuator assembly 106 is disengaged from the protuberances 104, the unhindered ball 102 can be freely moved to another angle. The actuators 108, compressed to various depths while engaged with the protuberances 104, regain their fully extended position and are ready to imprint the protuberances 104 at a different locking position. The actuators 108 are surrounded by an upstanding lip 110, which forms part of an entire structure intended to encapsulate the actuators 108 and the ball surface 102. This joint has two positions: a disengaged adjustment position that allows the orientation of the joint to be manipulated, and an engaged locking position, where the selected orientation is fixed.

The present positioning device 10 uses a similar locking principle to act as a three dimensional mechanical gear drive mechanism that features a permanent linkage between two engaging surfaces. This linkage enables a continuous flow between locking positions. By providing an adaptable surface with individually movable components, the versatility of the device is increased. Furthermore, unlike the multiple unidirectional joint systems commonly used for manipulator arms throughout the robotics industry, the new device is capable of replicating the three dimensional movements of pitch, yaw and roll from a single unit joint mechanism.

Referring to FIG. 2, continuously variable positioning device 10 includes a first body 12 having a first engagement surface 14 and a second body 16 having a second engagement surface 18. As depicted, second engagement surface 18 is arcuate, although it will be apparent from the discussion below that other shapes may also be possible. At least part of first engagement surface 14 is covered with a pattern of movable actuators 20. At least a part of second engagement surface 18 has an actuator engaging profile 22. As depicted in FIG. 2, actuator engaging profile 22 is made up of a pattern of protrusions and concavities. It will be understood that other patterns or designs may be used that involve, for example, ridges, valleys, holes, etc. Second engagement surface 18 is in contact with first engagement surface 14 such that at least some of the movable actuators 20 are depressed and other movable actuators 20 are extended to conform to actuator engaging profile 22. In so doing, first engagement surface 14 conforms to second engagement surface, such that a larger contact surface area is provided than would otherwise be possible. Second body 16 has a terminal device connection for connecting a device to second body 16, such as a prosthetic, or a robotic tool.

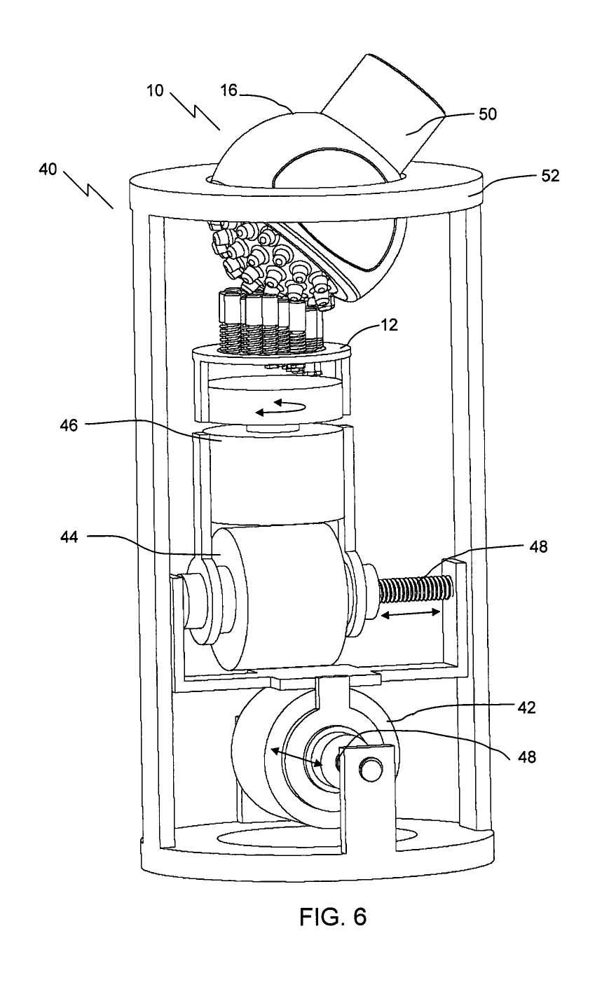

In contrast to the prior art, there is also provided means for creating relative movement of first body 12 and second body 16, while maintaining first engagement surface 14 continuously engaged with second engagement surface 18. Movable actuators 20 move axially during relative movement of first body 12 and second body 16. There may be different means for creating relative movement. In one embodiment, a drive assembly may be used to move either first body 12 or second body 16. An example of this is depicted in FIG. 6. In this embodiment, drive assembly 40 moves first body 12 laterally while second body 16 is secured in a housing to 52 cause it to move about a pivot point. The actuator may also rotate first body 12. By controlling the lateral movement and rotation of first body 12, the pitch, yaw and roll of second body 16 is also controlled. Alternatively, a different drive assembly may be provided that adjusts the pitch, yaw and/or roll of second body 16, which would then control the orientation of first body 12. In either of these embodiments, movable actuators 20 would be passive, spring loaded actuators to permit first engagement surface 14 to conform to second engagement surface 18 at all times. It will be understood that instead of a physical spring 21 as shown, actuators 20 may use a different type of compressible fluid or solid to provide a spring effect.

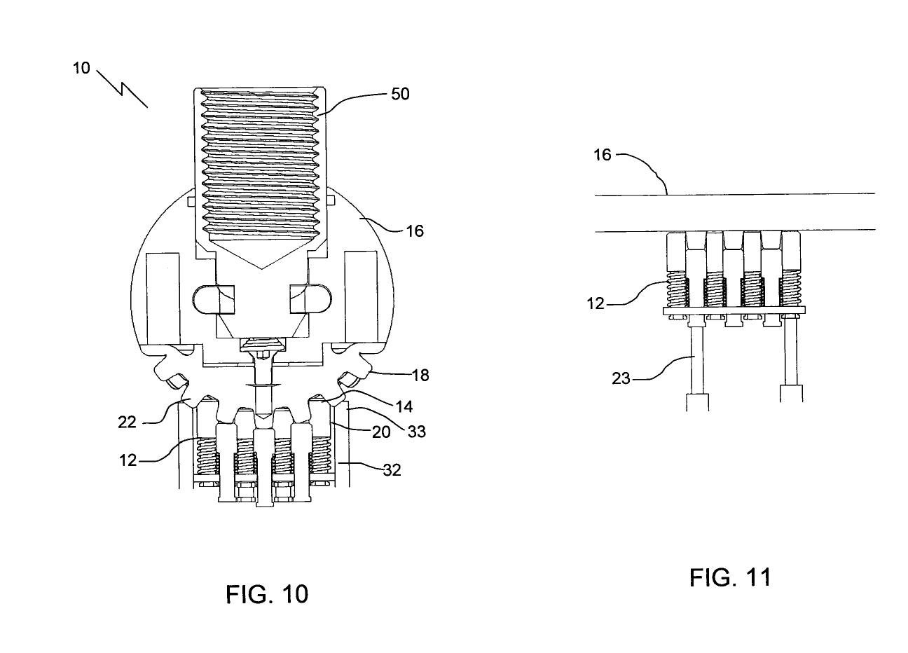

In another embodiment, referring to FIG. 11, some or all of movable actuators 20 are position-controllable, such that the position and orientation of second body 14 could be adjusted in a desired direction by extending some actuators 20, and retracting others. All actuators 20 need not be position controlled by, for example, a linear actuator 23 or a hydraulic system, with the remainder of actuators 20 being passive, spring loaded actuators.

In other embodiments, either or both of first body 12 may have arcuate, planar, or other shapes of engagement surfaces 14 and 18, depending on the preferences of the user. FIG. 11 shows an embodiment where both first body 12 and second body 16 are planar. Suitable adjustments to the rest of positioning device 10 will be recognized by those skilled in the art.

Referring to FIG. 6, additional details on drive mechanism 40 will now be given. Assembly actuator 40 has two linear drive mechanisms 42 and 44 and a rotating drive mechanism 46. Linear drive mechanism 42 and 44 control the lateral position of first body 12, while rotating drive mechanism 46 rotates first body 12 about an axis, in the directions indicated by the arrows. Linear drive mechanisms 42 and 44 move along horizontal shafts 48. Each moves first body 12, as well as the drive mechanisms between it and first body 12, in the associated direction. Rotating drive mechanism 46 rotates first body 12. The three drive mechanisms 42, 44, 46 work together to control the roll, pitch and yaw of second body 16 and any terminal device attached thereto. These drive mechanisms 42, 44, 46 may also be programmed to move second body 16 along a specific movement path. In some situations, it may be preferable to provide a computer to control drive mechanisms 42, 44, 46 to achieve precise movements and positions.

Referring to FIG. 7, an alternative drive mechanism 24 is shown. Drive mechanism 24 is connected to move first body 12, and has a planar drive mechanism 26 and a rotating drive mechanism 27. Planar drive mechanism 26 includes a threaded shaft 28 that moves a platform 30 when rotated, or two as shown. Platform 30 is attached to first body 12. Threaded shafts 28 have a gear 34 mounted at each end, such that, as gears 34 turn, the orientation of threaded shaft 28 is changed. This allows threaded shaft 28 to move first body 12 laterally in any two-dimensional direction. Rotating drive mechanism 27 is carried by, or moves with, planar drive mechanism 26 and rotates first body 12. By controlling the movement of both planar element 26 and rotating element 27, the pitch, roll and yaw of second body 16 can be adjusted in a smooth, continuous fashion, and even through a desired path of travel.

It can be seen from the two examples given above that drive mechanism controls the lateral and rotational position of first body 12 and thus the roll, pitch and yaw of second body 16. Other designs that provide the necessary range of motions will be apparent to those skilled in the art beyond those depicted and described. However, the drive mechanisms described above have the advantage of being able to fit within a narrow housing, which may be important if device 10 is used, for example, as a wrist joint for a robotic arm.

In a preferred embodiment, a two-dimensional electronic positioning system acts as the control center for positioning device 10. The positioning system is capable of controlling the directional and rotational movements of first body 12 interlinked with its race counterpart. Simultaneous directional and rotational changes by the actuator assembly triggers a true representation of all the three-dimensional movements while constantly maintaining a true 3D interlock between the ball race 18 and actuators 20 throughout the entire repositioning process.

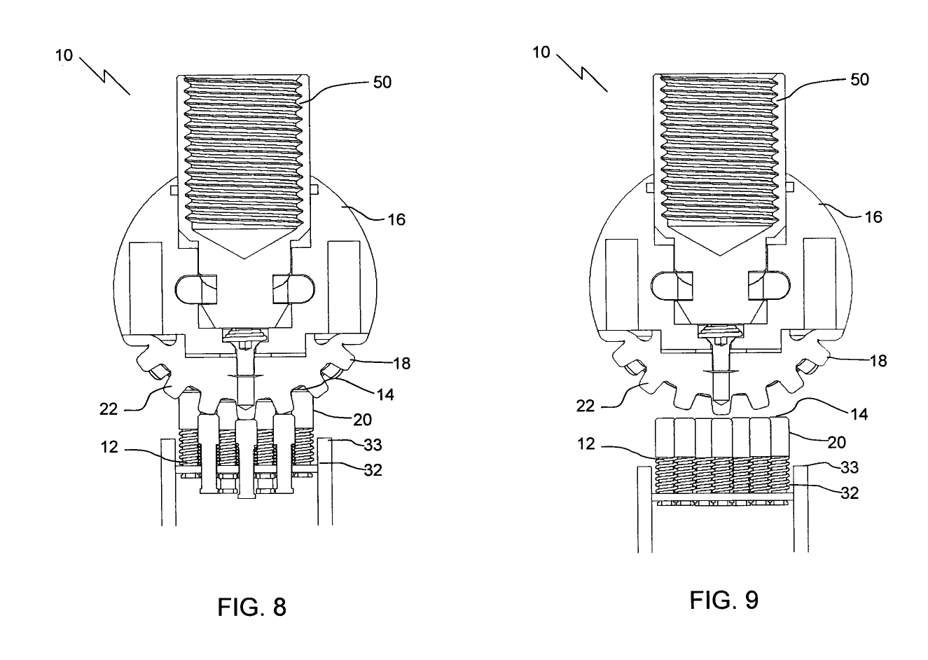

In another embodiment, referring to FIG. 8 through 10, the axial position of a movable actuator assembly 32 relative to second body 16 may be controlled. Referring to FIG. 8, movable actuator assembly 32 includes first body 12 and an outer enclosure 33. Outer enclosure 33 may move with first body 12, independently of first body 12, or a combination of both. This allows a user to select the intermediate, movable position shown in FIG. 8, to disengage first and second engagement surfaces 14 and 18 as shown in FIG. 9, or to lock device 10 by causing movable actuator assembly 32 to engage second engagement surface 18 as shown in FIG. 10. As movable actuator assembly 32 does not conform to second body 16 as do movable actuators 20, the relative position of first and second bodies 12 and 16 will become locked. This may be useful in situations where, for example, a large force will be applied to one or the other bodies, or if the user wishes to ensure that the position will not accidentally change.

Below is a discussion of the preferred embodiment, where a ball joint is provided that is connected to a suitable terminal device (e.g. a prosthetic hand or robotic tool) by a connector 50, held in place by a shell-like enclosure, such as a stationary, immovable metal ring (not shown), and is able to move completely around its own axis and/or tilt in all directions within its confines. For example, a tilt of up to 50 degrees from center may be permitted, or using other designs, a tilt of more than 90 degrees from center may be achieved. A portion of the ball 16 is comprised of ball race protuberances that are permanently interlinked with a crown of pressure sensitive, spaced actuators 20. The resulting coupling is supple and extremely flexible.

Bound by that physical linkage, the closely interdependent parts can only move as a union, each part with the other in tow. The actuator assembly thus controls the movement of the ball joint 10. When the actuator assembly moves within a small horizontal orbital plane, it directs the angular and rotational deviations of the ball-race and consequently the terminal device attached thereto. Every degree of tilt and/or axial rotation by the terminal device is directly proportional to the directional changes made by the actuators. In essence, the two components move in tow, with every directional change by the actuator assembly within the periphery of a horizontal orbital platform directly related to the degree of tilt or axial rotation of the terminal device.

This embodiment is able to work due to the unique shape of the ball race protuberances and their ability to interact with the actuators. Directional changes by the drive mechanism triggers a reaction between the two entities, whereby the tips of the pressure sensitive actuators continuously self adjust their various extensions into the concavities between the race protrusions as they yield to the fluctuating pressures of the protuberances in a smooth cam action. To safeguard the unhindered self-adjustment of actuators, the ball-race protuberances must not contact the top rim of the actuator enclosure while being manipulated. The counteracting interdependency between actuators and protuberances tilts the terminal device to the left when the actuator assembly is moved to the right and vise versa. A turning motion of the actuator entity causes the terminal device to tag along a 360 degree pathway whatever the preset angle.

The chaotic interplay between protuberances and the closely spaced actuators can be replaced by two highly compatible interlinking surfaces. Spacing the actuators to fit the openings between protuberances modeled according to the divisions of a platonic solid. For example, the shape of actuators and protuberances may be optimized by using an icosahedron geometry. Furthermore, changing the height of protuberances and lengthening the protruding actuators, will alter the depth of penetration between the two entities. Various depths of penetration as well as enhanced locking characteristics can also be achieved by raising or lowering the actuator assembly.

### ADVANTAGES

This device may be used in a multitude of robotic applications. A vital key to the successful development of compact, single unit 3D joint modules is the ability to power a robotic joint between locking positions. It is anticipated that this technology could replace the successive pitch, yaw and roll movements used in the wrist assemblies of current manipulator arms in appropriate circumstances.

In theory, a minimum of two actuators are required to block all three degrees of physical freedom. The advantage of increasing that number several times assures the distribution of external forces over a broad surface area. Large numbers of penetrating actuators also give a significant boost to the weight bearing ability of the joint system. Depending on the application the actuator assembly may be closely spaced or individually guided. According to the FEA (Finite Element Analysis) report, the overall joint strength doubles by increasing the diameter of actuators and protuberances 26%.

Other advantages of this design include:
Unlimited 3D locking positions at any plane or angle within operating range
Self-varying, self engaging core surfaces
Suitable for 1D, 2D & 3D joint applications
Instant 3D locking at all locking sites/Manual or electronic control
Unequalled locking & weight bearing strength against forces of pitch, yaw and roll

### Variations:

The above description and drawings have described an embodiment where the locking profile is made up primarily of a series of protuberances and concavities. It has been found that this provides an economical and practical solution for providing two surface that interlock when engaged. It will be understood, however, that other locking profiles may also be used. For example, the locking profile may consist of a series of ridges or valleys that would depress some actuators and engage others. The locking profile may be designed with depressions, extensions, or combinations of the two. Other patterns for locking profile and actuators will be apparent to those skilled in the art.

The above description also focused on the situation where the first body is moved laterally in order to change the pitch and yaw of the second body. However, different movements are also possible. For example referring to FIG. 11, the height of some or all pistons may be controlled, such that the second body may be “pushed” in a certain direction to obtain the desired movement. In this case, the first body would remain stationary, and the second body you move laterally in addition to changing its pitch and yaw. Furthermore, using this design, it would be possible to control the orientation of a body with a flat surface, rather than a rounded surface as depicted. The position-controlled actuators would push the body and cause its orientation to change.

It is also possible to have a rounded second body control the position of the first body by adjusting the orientation of the first body. As the second body moved about its pivot point, the moving locking engagement would apply a force to the actuators to cause them, and thus the first body, to move laterally.

To better follow the curvature of the ball, the assembly of actuators may consist of three different actuator lengths, the outermost being the tallest. The interaction between actuators and protuberances causes the tips of the motion sensitive spring-loaded actuators to yield to the varying pressures of the conically shaped ball-race protuberances. While the steel enclosed actuator assembly is in motion, the actuators continuously self adjust their varying extensions into the cluster of protuberances in a smooth cam action like fashion. To assure the unhindered self adjustment of the actuators it is of critical importance that the protuberances on full impact with the actuators stay spaced from the top rim of the steel actuator enclosure. Throughout this entire repositioning process, the union between actuators and protuberances retains its 3D interlock against external multilateral forces. The ball-race for a possible wrist-joint application could feature an open central core to accommodate wire harness connections, while the crown of actuators may be ring-shaped to allow unimpeded access for electronic circuitry.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A continuously variable positioning device, comprising:
a first body having a first engagement surface, at least part of the first engagement surface being covered with a pattern of movable actuators;
a second body having a second engagement surface in contact with the first engagement surface, at least a part of the second engagement surface having an actuator engaging profile, at least some of the movable actuators being depressed and others of the movable actuators being extended to conform to the actuator engaging profile;
means for creating relative movement of the first body and the second body while maintaining the first engagement surface continuously engaged with the second engagement surface, the movable actuators moving axially during relative movement of the first body and the second body.

2. The continuously variable positioning device of claim 1, wherein the actuator engaging profile comprises a pattern of protrusions and concavities.

3. The continuously variable positioning device of claim 1, wherein the movable actuators are spring loaded actuators.

4. The continuously variable positioning device of claim 1, wherein the means for creating relative movement comprises position-controlled movable actuators.

5. The continuously variable positioning device of claim 1, wherein the means for creating relative movement moves at least one of the first body and the second body.

6. The continuously variable positioning device of claim 1, wherein the means for creating relative movement comprises at least one drive assembly.

7. The continuously variable positioning device of claim 6, wherein the at least one drive assembly changes at least one of the pitch, yaw and roll of the first body.

8. The continuously variable positioning device of claim 6, wherein the at least one drive assembly comprises a planar drive assembly and a rotating drive assembly, the planar drive assembly moving the first body laterally and the rotating drive assembly rotating the first body, where the rotating drive assembly is carried by the planar drive assembly.

9. The continuously variable positioning device of claim 1 further comprises means for rotating at least one of the first body and the second body.

10. The continuously variable positioning device of claim 1, wherein the second engagement surface is one of a flat surface and an arcuate surface.

11. The continuously variable positioning device of claim 1, wherein the movable actuators are housed within an actuator assembly, the actuator assembly being axially movable relative to the second body,

12. The continuously variable positioning device of claim 11, wherein the actuator assembly is movable in first and second axial directions, the actuator assembly having a disengaged position where the first and second engagement surfaces are disengaged, an intermediate drive position where relative movement of the first and second bodies is permitted, and a third locked position where relative movement of the first and second bodies is not permitted.

13. The continuously variable positioning device of claim 6, where the at least one drive assembly maintains the first body and the second body in a select position when the at least one drive assembly is not activated.

14. The continuously variable positioning device of claim 1, wherein the first engagement surface engages the second engagement surface such that pitch, yaw and roll movements are controlled by the relative movement of the first body and the second body.
